(19) United States
(12) Patent Application Publication
(10) Pub. No.: US 2017/0367386 A1
(43) Pub. Date: Dec. 28, 2017

(54) TERPENE FLAVORING COMPOSITIONS

(71) Applicant: Allied Concessions Group, Inc., Denver, CO (US)

(72) Inventors: Christopher McElvany, Denver, CO (US); Sam Singh, Denver, CO (US)

(21) Appl. No.: 15/632,075

(22) Filed: Jun. 23, 2017

Related U.S. Application Data
(60) Provisional application No. 62/354,578, filed on Jun. 24, 2016.

(51) Int. Cl. A23L 27/10; A23L 27/00; A23L 27/20; A23L 2/56

(52) U.S. Cl. CPC A23L 27/10; A23L 2/56; A23L 27/80; A23L 27/20

(57) ABSTRACT

Terpene flavoring compositions, methods of using them to flavor foods, beverages, or vaporizer compositions, and methods of making and consuming these compositions.

### CROSS-REFERENCE TO RELATED APPLICATIONS

This application claims the benefit of and priority to U.S. provisional patent application Ser. No. 62/354,578, filed Jun. 24, 2016, which is incorporated herein by reference in its entirety.

### TECHNICAL FIELD

The present technology relates to liquid terpene flavoring compositions for use in foods, beverages, and vaporizer compositions.

### BACKGROUND

The manufacture of foods, drinks, and smoked or vaporized substances typically involves heavy use of flavorings to increase the consumer's preference for them. However, many flavorings are not highly stable and may therefore diminish or disappear in the process of heat treatment, such as sterilization or vaporization and during storage, so efforts are being made to devise ways to make pleasing and stable flavoring compositions.

Vaporizers can be filled with liquid compositions to be vaporized. Such liquid compositions generally include a liquid base and one or more other components. Typical vaporizer liquid bases include propylene glycol, glycerol, PEG-400, or lipid compositions comprising medium chain triglycerides, or other fatty acids, and they are primarily intended to function with the addition of water-soluble additives.

Manufacturers of foods, beverages, and vaporizer liquids have had difficulty creating a stable emulsion containing oil-soluble compounds. The vaporizer liquids presently on the market typically have an off palate and/or do not perform well, due to a waxy ballast discharge, terpenoid loss, separation from base liquid, the presence of self-emulsifying agents creating a range of viscosity, and/or unstable and unrefined emulsions. Some emulsifiers will thermally decompose and produce carcinogenic byproducts with intolerable flavor.

Besides the delivery of nicotine in e-cigarettes, vaporizers can also be used for the delivery of cannabinoids, or cannabis extracts. The National Institutes of Health (NIH) released a review of the scientific data concerning potential therapeutic uses for marijuana in 1997. In that review, the NIH found that marijuana may have beneficial medicinal effects and recommended that researchers develop alternative dosage forms for the drug, such as a “smoke free” inhaled delivery system. Various studies have documented therapeutically beneficial medicinal uses of the major active component of marijuana, delta-9-tetrahydrocannabinol (THC). See U.S. Pat. No. 6,713,048, entitled “Δ9 tetrahydrocannabinol (Δ9 THC) solution metered dose inhalers and methods of use”. Makers of vaporizer liquids containing oil-soluble compounds, or resins, have had difficulty creating a stable emulsion, and the vapor liquids presently on the market typically have an undesirable taste and/or do not perform well for the reasons mentioned above.

PCT patent application publication No. WO 02/064109 discloses a method of preparing an extract from medicinal cannabis. The process includes (1) a heating step to decarboxylate the acid form of the cannabinoids to their neutral form; (2) a first extraction with a specified volume of liquid carbon dioxide for 6-8 hours; and (3) a step to reduce the proportion of non-target materials, referred to as winterization, which precipitates out waxes. More specifically, step (1) comprises heating chopped cannabis at 100-150° C. for sufficient time to allow decarboxylation. Step (2) comprises CO₂ extraction using supercritical conditions. Step (3) comprises conducting an ethanol precipitation at −20° C. for 24 hours and removing the waxy material by filtration.

U.S. Pat. No. 6,946,150 describes formulations containing cannabinoids for administration via a pump action spray. In particular, the invention relates to pharmaceutical formulations, for use in administration of lipophilic medicaments via mucosal surfaces, comprising at least one lipophilic medicament, a solvent and a co-solvent and/or a fluorinated propellant.

U.S. Pat. No. 7,344,736 also describes extraction of cannabinoids from cannabis using liquid carbon dioxide, as well as winterization to remove waxy material. The patent relates preparation of a botanical drug substance (BDS) for incorporation into a medicament. It also relates to a BDS of given purity, for use in pharmaceutical formulations. In particular, it relates to BDS comprising cannabinoids obtained by extraction from cannabis. For example, the patent discusses an extraction process where a botanical raw material is decarboxylated by heating to approximately 105° C. for 15 minutes, followed by approximately 145° C. for a minimum of 55 minutes for THCA and 90 minutes for CBDA. An extraction with food grade liquid carbon dioxide (CO₂) for up to 10 hours at a pressure of approximately 60 bar+/−10 bar and 10° C.+/−5° C. The CO₂ is removed by depressurization to recover crude extract.

There is a need in the art for additional ways to flavor foods, beverages, and the liquid compositions for vaporizers that are pleasant tasting, and reliably stable. More particularly, there is a need for a manner or mechanism by which one can mix and match one or more flavors to easily edit, adjust, change, or increase the amount of flavor combinations available.

### SUMMARY

This disclosure provides flavoring compositions that are based on the inventors' discovery of terpene compositions that are stable and found to impart a pleasing taste to foods, beverages and to the vapor created from vaporizer compositions. These compositions comprise a base composition of terpenes that can be amended or adjusted with additional, optional, terpene additives that adjust or amend the taste of the resulting compositions as requested by customer preferences.

The terpene flavoring compositions of this disclosure comprise α-pinene, β-pinene, myrcene, limonene, α-humelene, β-caryophyllene, and camphene.

The terpene flavoring compositions of this disclosure optionally comprise one or more additional terpene(s) selected from the group consisting of α-phellandrene, 3-carene, α-terpinene, limonene, terpinolene, linalool, fenchol, borneol, terpineol, geraniol, β-caryophyllene, caryophyllene oxide, α-bisabolol, ocimene, sabinene, camphor, isoboneol, menthol, α-cedrene, nerolidol, r-(+)-pulegone, eucalyptol, p-cymene, (−)-isopulegol, geranyl acetate, guaiol, valecene, phytol, and citronellol.

The terpene flavoring compositions of this disclosure may be formulated in any suitable base solution. The base solution is preferably a non-aqueous base solution. These base solutions may include one or more of propylene glycol, glycerol, PEG-400, fatty acids, and medium chain triglycerides.

The terpene flavoring compositions of this disclosure are useful as direct flavoring agents, and may therefore be used by adding the flavoring compositions directly to foods, beverages, or vaporizer compositions in amounts sufficient to impart a pleasing taste to the food, beverage, or vapor created from the vaporizer composition.

This Summary is neither intended nor should it be construed as being representative of the full extent and scope of the present disclosure. Moreover, references made herein to “the present disclosure,” or aspects thereof, should be understood to mean certain embodiments of the present disclosure and should not necessarily be construed as limiting all embodiments to a particular description. The present disclosure is set forth in various levels of detail in this Summary as well as in the attached drawings and the Description of Embodiments and no limitation as to the scope of the present disclosure is intended by either the inclusion or non-inclusion of elements, components, etc. in this Summary. Additional aspects of the present disclosure will become more readily apparent from the Description of Embodiments, particularly when taken together with the drawings.

### DESCRIPTION OF EMBODIMENTS

The present disclosure is drawn to a terpene flavoring composition that imparts a pleasant flavor to foods, beverages and vapor created from vaporizer compositions, and is sufficiently stable to impart a consistent, pleasant flavor to these materials for many months, or longer.

Additionally, this disclosure relates to methods to mix flavors for liquids intended for use in electronic cigarettes or vaporizers. Such liquids used with electronic cigarettes or vaporizers, including personal vaporizers, may often be referred to as “vaporizer compositions.”

Vaporizer compositions may be a liquid solution, which may include, but is not limited to, propylene glycol, glycerin, nicotine, and other flavorings. The liquid is designed to be used in an electronic cigarette, personal vaporizer, or electronic nicotine or cannabinoid delivery system (herein referred to collectively as a vaporizer). The liquid may be consumed as the vaporizer is used. The liquid container within the vaporizer may be designed for a one time use. However, liquid containers may also be designed for repeated and continued use. The liquid may or may not contain nicotine and/or cannabinoid(s).

The flavor compositions of this disclosure may be added to an existing food, beverage or vaporizer composition to impart a pleasing taste to the material or vapors created from these materials. Alternatively or additionally, the flavor compositions of this disclosure may be formulated as part of a food, beverage, or vaporizer composition as the food, beverage, vaporizer materials are being produced to impart a pleasing taste to the material or vapors created from these materials. Alternatively or additionally, a user or consumer of a food, beverage, or vaporizer composition may add a flavor composition of this disclosure to a food, beverage, or vaporizer composition immediately prior to, or at the time of, consumption or use of the material. For these uses, the user may have a one-time use or multi-use package of a flavor composition of this disclosure.

This disclosure also provides a container holding a liquid flavoring composition of this disclosure, which liquid may be added to a food, beverage or vaporizer composition. The container may hold a liquid flavoring composition that includes a nicotine or cannabis extract suitable for vaporization and inhalation. The liquid composition contains a flavoring composition of this disclosure and may further include a nicotine or cannabis extract, optionally with a co-solvent (such as propylene glycol or polyethylene glycol). The liquid terpene composition is stable and may include other components. The container may be adapted for attachment to, or is part of, a vaporizer.

Another aspect of this disclosure is a kit which includes a vaporizer, one or more containers adapted for attachment to a vaporizer containing a liquid terpene flavoring composition of this disclosure, and optionally a battery, and/or battery charger, and/or instructions for use.

The flavor compositions of this disclosure include the following terpenes: α-pinene, β-pinene, myrcene, limonene, α-humelene, β-caryophyllene, and camphene.

Additional terpenes that may optionally be added to, or may be included within, the flavor compositions of this disclosure include any terpene selected from α-phellandrene, 3-carene, α-terpinene, limonene, terpinolene, linalool, fenchol, borneol, terpineol, geraniol, β-caryophyllene, caryophyllene oxide, α-bisabolol, ocimene, sabinene, camphor, isoboneol, menthol, α-cedrene, nerolidol, r-(+)-pulegone, eucalyptol, p-cymene, (−)-isopulegol, geranyl acetate, guaiol, valecene, phytol, citronellol, and combinations thereof.

All of these terpene compounds are available commercially from several commercial chemical sources. Exemplary commercial sources of terpenes include, but are not limited to, Buy-Terpenes (buy-terpenes.com), VWR (Radnor, Pa.). Therefore, the terpene flavoring compositions of this disclosure may be easily formed by obtaining the individual terpene compounds and mixing them in the appropriate amounts to form a pleasing terpene flavoring composition of this disclosure.

The flavoring compositions of this disclosure may include, or may be mixed with, a cannabis extract that contains one or more cannabinoid compounds selected from: cannabidiol (CBD), delta-9-tetrahydrocannabinol (THC), cannabidiolic acid (CBDA), tetrahydrocannabinolic acid (THCA), cannabinol (CBN), cannabichromene (CBC), cannabigerol (CBG), delta-8-THC (delta-8-THC), tetrahydrocannabivarin (THCV), and combinations thereof.

Additional components that may be included in the flavoring compositions of this disclosure may include cannabinoids, nicotine, taurine, caffeine, tryptophan, gamma-aminobutyric acid, melatonin, epimedium, yohimbine, and others.

Another embodiment of the disclosure relates to the use of any of the terpene flavoring compositions of this disclosure in the preparation of a flavored food, beverage, or vaporizer composition.

Each publication or patent cited in this disclosure is incorporated herein by reference in its entirety.

The disclosure now being generally described will be more readily understood by reference to the following examples, which are included merely for the purposes of illustration of certain aspects of the embodiments of the present disclosure. The examples are not intended to limit the disclosure, as one of skill in the art would recognize from the above teachings and the following examples that other techniques and methods can satisfy the claims and can be employed without departing from the scope of the claimed disclosure.

### EXAMPLES

### Example 1

An exemplary flavoring composition is formed as set forth in the following table:

| Terpene | mg/g |
|---|---|
| a-Pinene | 0.56 |
| Myrcene | 4.76 |
| a-Phellandrene | 0 |
| Limonene | 6.75 |
| Fenchol | 0.45 |
| Borneol | 0.17 |
| Terpineol | 0.06 |
| a-Humelene | 1.11 |
| b-Caryophyllene | 3.54 |
| Caryophyllene | 0.02 |
| Oxide | |
| a-Bisabolol | 0.37 |
| Camphene | 0.18 |
| b-Pinene | 1.02 |
| Camphor | 0.05 |
| Nerolidol | 0.08 |
| Valecene | 0.13 |
| Phytol | 0.09 |

### Example 2

An exemplary flavoring composition is formed as set forth in the following table:

| Terpene | mg/g |
|---|---|
| a-Pinene | 0.4 |
| Myrcene | 1.01 |
| a-Phellandrene | 0.21 |
| 3 Carene | 0.26 |
| a-terpinene | 0.21 |
| Limonene | 0.78 |
| Terpinolene | 6.55 |
| Fenchol | 0.07 |
| Borneol | 0.02 |
| a-Humelene | 0.23 |
| b-Caryophyllene | 0.45 |
| Caryophyllene Oxide | 0.02 |
| Camphene | 0.02 |
| b-Pinene | 0.6 |
| Ocimene | 0.78 |
| Sabinene | 0.02 |
| Camphor | 0.01 |
| Nerolidol | 0.01 |
| Eucalyptol | 0.05 |
| Guaiol | 0.21 |
| Phytol | 0.14 |

### Example 3

An exemplary flavoring composition is formed as set forth in the following table:

| Terpene | mg/g |
|---|---|
| a-Pinene | 293.71 |
| Myrcene | 186.56 |
| a-Phellandrene | 31.15 |
| Limonene | 69.2 |
| Terpinolene | 1.29 |
| Linalool | 3.5 |
| Terpineol | 0.4 |
| a-Humelene | 50.82 |
| b-Caryophyllene | 101.07 |
| a-Bisabolol | 3.63 |
| Camphene | 14.35 |
| b-Pinene | 90.19 |
| Isoboneol | 3.02 |
| Nerolidol | 21.3 |
| R-(+)-Pulegone | 5.86 |
| Eucalyptol | 9.07 |
| Geranyl Acetate | 3.08 |

### Example 4

An exemplary flavoring composition is formed as set forth in the following table:

| Terpene | mg/g |
|---|---|
| a-Pinene | 0.59 |
| Myrcene | 0.09 |
| Limonene | 5.52 |
| Terpinolene | 0.04 |
| Linalool | 0.67 |
| Fenchol | 0.64 |
| Terpineol | 0.32 |
| a-Humelene | 2.26 |
| b-Caryophyllene | 7.2 |
| Caryophyllene Oxide | 0.05 |
| a-Bisabolol | 0.75 |
| Camphene | 0.2 |
| b-Pinene | 1.15 |
| Camphor | 0.08 |
| Valecene | 0.1 |
| Phytol | 0.09 |

### Example 5

An exemplary flavoring composition is formed as set forth in the following table:

| Terpene | mg/g |
|---|---|
| a-Pinene | 0.97 |
| Myrcene | 0.72 |
| Limonene | 5.61 |
| Linalool | 0.68 |
| Fenchol | 0.91 |
| Terpineol | 0.41 |
| Geraniol | 0.07 |
| a-Humelene | 0.64 |
| b-Caryophyllene | 2.03 |
| a-Bisabolol | 0.25 |
| Camphene | 0.16 |
| b-Pinene | 1.19 |
| Ocimene | 0.44 |
| Nerolidol | 0.51 |
| R-(+)-Pulegone | 0.1 |
| Geranyl Acetate | 0.27 |
| Phytol | 0.21 |
| Citronellol | 0.05 |

### Example 6

An exemplary flavoring composition is formed as set forth in the following table:

| Terpene | mg/g |
|---|---|
| a-Pinene | 0.63 |
| Myrcene | 3 |
| Limonene | 5.93 |
| Terpinolene | 0.17 |
| Linalool | 1.55 |
| Fenchol | 0.63 |
| Terpineol | 0.06 |
| Geraniol | 0.07 |
| a-Humelene | 1.07 |
| b-Caryophyllene | 3.43 |
| a-Bisabolol | 0.2 |
| Camphene | 0.2 |
| b-Pinene | 1.06 |
| Ocimene | 0.01 |
| Sabinene | 0.01 |
| Nerolidol | 0.5 |
| (−)-isopulegol | 0.06 |
| Geranyl Acetate | 0.12 |
| Valecene | 0.07 |
| Phytol | 1.2 |
| Citronellol | 0.135 |

### Example 7

An exemplary flavoring composition is formed as set forth in the following table:

| Terpene | mg/g |
|---|---|
| a-Pinene | 1 |
| Myrcene | 3.44 |
| Limonene | 0.64 |
| Fenchol | 0.32 |
| Borneol | 0.21 |
| a-Humelene | 2.15 |
| b-Caryophyllene | 5.32 |
| Caryophyllene Oxide | 0.65 |
| a-Bisabolol | 1.18 |
| Camphene | 0.08 |
| b-Pinene | 0.73 |
| Eucalyptol | 0.91 |
| Guaiol | 1.2 |
| Phytol | 0.26 |

### Example 8

An exemplary flavoring composition is formed as set forth in the following table:

| Terpene | mg/g |
|---|---|
| a-Pinene | 3.3 |
| Myrcene | 1.81 |
| a-Phellandrene | 0.04 |
| 3 Carene | 0.18 |
| a-terpinene | 0.05 |
| Limonene | 3 |
| Terpinolene | 0.57 |
| Fenchol | 0.62 |
| a-Humelene | 1.85 |
| b-Caryophyllene | 5.2 |
| Caryophyllene Oxide | 1.44 |
| a-Bisabolol | 1.98 |
| Camphene | 0.25 |
| b-Pinene | 0.96 |
| Guaiol | 0.57 |
| Valecene | 0.18 |
| Phytol | 0.04 |

### Example 9

An exemplary flavoring composition is formed as set forth in the following table:

| Terpene | mg/g |
|---|---|
| a-Pinene | 4.44 |
| Myrcene | 4.48 |
| 3 Carene | 0.24 |
| Limonene | 2.02 |
| Fenchol | 0.05 |
| a-Humelene | 4.09 |
| b-Caryophyllene | 11.84 |
| Caryophyllene Oxide | 1.7 |
| Camphene | 0.27 |
| b-Pinene | 2.31 |
| Eucalyptol | 0.73 |
| Valecene | 0.49 |
| Phytol | 0.7 |

The foregoing examples of the present invention have been presented for purposes of illustration and description. Furthermore, these examples are not intended to limit the invention to the form disclosed herein. Consequently, variations and modifications commensurate with the teachings of the description of the invention, and the skill or knowledge of the relevant art, are within the scope of the present invention. The specific embodiments described in the examples provided herein are intended to further explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

What is claimed is:

1. A terpene flavoring composition comprising α-pinene, β-pinene, myrcene, limonene, α-humelene, β-caryophyllene, and camphene.

2. The terpene flavoring composition of claim 1, further comprising one or more additional terpene(s) selected from the group consisting of α-phellandrene, 3-carene, α-terpinene, limonene, terpinolene, linalool, fenchol, borneol, terpineol, geraniol, β-caryophyllene, caryophyllene oxide, α-bisabolol, ocimene, sabinene, camphor, isoboneol, menthol, α-cedrene, nerolidol, r-(+)-pulegone, eucalyptol, p-cymene, (−)-isopulegol, geranyl acetate, guaiol, valecene, phytol, and citronellol.

3. The terpene flavoring composition of claim 1, formulated in a non-aqueous base solution.

4. The terpene flavoring composition of claim 1, wherein the base solution comprises at least one of propylene glycol, glycerol, PEG-400, ethyl alcohol, benzyl alcohol, glycerin, fatty acids, and medium chain triglycerides.

5. The terpene flavoring composition of claim 4, wherein the base solution further comprises water.

6. The terpene flavoring composition of claim 1, wherein the α-pinene is present in the composition in an amount between about 0.3 mg/ml and about 5 mg/ml.

7. The terpene flavoring composition of claim 1, wherein the β-pinene is present in the composition in an amount between about 0.5 mg/ml and about 95 mg/ml.

8. The terpene flavoring composition of claim 1, wherein the myrcene is present in the composition in an amount between about 0.05 mg/ml and about 195 mg/ml.

9. The terpene flavoring composition of claim 1, wherein the limonene is present in the composition in an amount between about 0.5 mg/ml and about 75 mg/ml.

10. The terpene flavoring composition of claim 1, wherein the α-humelene is present in the composition in an amount between about 0.1 mg/ml and about 55 mg/ml.

11. The terpene flavoring composition of claim 1, wherein the β-caryophyllene is present in the composition in an amount between about 0.3 mg/ml and about 110 mg/ml.

12. The terpene flavoring composition of claim 1, wherein the camphene is present in the composition in an amount between about 0.01 mg/ml and about 18 mg/ml.

13. A terpene flavoring composition comprising:

| Terpene | mg/g |
|---|---|
| α-Pinene | 0.3-5.0 |
| Myrcene | 0.5-95.0 |
| Limonene | 0.5-75.0 |
| α-Humelene | 0.1-55.0 |
| β-Caryophyllene | 0.3-110.0 |
| Camphene | 0.01-18.0 |
| β-Pinene | 0.5-95.0 |

14. The terpene flavoring composition of claim 13, formulated in a non-aqueous base solution.

15. The terpene flavoring composition of claim 14, wherein the base solution comprises at least one of propylene glycol, glycerol, PEG-400, ethyl alcohol, benzyl alcohol, glycerin, fatty acids, and medium chain triglycerides.

16. A method of flavoring a food or beverage comprising adding a flavoring composition of claim 13 directly to a food or beverage.

17. A method of flavoring a vaporizer composition comprising adding a flavoring composition of any one of claim 13 to a vaporizer composition.

18. A vaporizer composition comprising at least one of nicotine and a cannabinoid, and a flavoring composition of claim 13.
